(19) United States
(12) Patent Application Publication
(10) Pub. No.: US 2018/0038618 A1
(43) Pub. Date: Feb. 8, 2018

(54) LUBRICANT SEPARATOR

(71) Applicant: TRANE INTERNATIONAL INC., Davidson, NC (US)

(72) Inventors: Jon P. HARTFIELD, La Crosse, WI (US); Harry Kenneth RING, Houston, MN (US)

(21) Appl. No.: 15/549,211

(22) PCT Filed: Feb. 5, 2016
(86) PCT No.: PCT/US2016/016794

§ 371 Date: Aug. 7, 2017

Related U.S. Application Data
(60) Provisional application No. 62/112,849, filed on Feb. 6, 2015.

(51) Int. Cl. F25B 43/02; F25J 3/02; B01D 45/12; F25B 45/00

(52) U.S. Cl. CPC F25B 43/02; F25B 45/00; F25J 3/02; B01D 45/12; F25B 2400/075

(57) ABSTRACT

A cyclonic type lubricant separator with various features that reduces pressure losses, manages local gas velocities which may contribute to entrainment of liquid(s) (e.g. oil), maintains and/or improves oil separation (e.g. achieving lower oil circulation rates), reduces the size of the lubricant separator, and/or reduces or minimizes costs of production. Lubricant separators herein include a shell, a fluid inlet, a vapor outlet, a liquid outlet, and a discharge tube within the shell. Lubricant separators herein include multiple inlets that have openings such that the discharge tube is out of sight relative to the openings of the inlet, include openings along the length of the discharge tube, and/or include a flow director on the discharge tube, where the flow director includes a surface that extend away from the outer dimension of the discharge tube.

### FIELD

Embodiments disclosed herein relate generally to lubricant separators, such as for example an oil separator. In particular, apparatuses, systems and methods are directed to lubricant separators, such as for example cyclonic type lubricant separators, which may be implemented in fluid systems. Such fluid systems include for example refrigeration or cooling systems and/or heating, ventilation, and air conditioning (HVAC) systems, which employ refrigerant as a working fluid.

### BACKGROUND

Cyclonic lubricant separators receive a fluid mixture, including a lubricant such as for example oil and other vapor(s) (e.g. refrigerant gas) and/or liquid(s). The fluid mixture is received by the separator through an inlet, flows into the shell of the separator, swirls within the shell, where the oil adheres around the inner surfaces (e.g. sides) of the shell inside the separator. The refrigerant gas can continue to swirl and be separated from the oil, be released into a suction or discharge tube that is placed within the shell, and then exit the separator. The separated oil has a different momentum than the vapor and flows to a bottom sump and drains out of the shell.

### SUMMARY

Improvements may be made to lubricant (e.g. oil) separators, such as for example cyclonic type oil separators. Lubricant separators herein include various features that provide one or more of the advantages of reducing pressure losses, addressing local gas velocities which may contribute to entrainment of liquid(s) (e.g. oil), maintaining and/or improving oil separation (e.g. achieving lower oil circulation rates), reducing the size of the lubricant separator, and/or reducing or minimizing costs of production.

In one embodiment, lubricant separators herein include a shell, a fluid inlet, a vapor outlet, a liquid outlet, and a discharge tube within the shell. Various embodiments herein of the lubricant separator features, including for example, the fluid inlet and/or the discharge tube can provide the one or more above advantages.

In some embodiments, the fluid inlet comprises multiple inlets.

In some embodiments, the inlet(s) each have an opening such that the majority of the discharge tube is out of sight relative to the opening(s) of the inlet(s). In some embodiments, the opening(s) are configured so that the discharge tube is out of sight relative to the opening(s) of the inlet(s).

In one embodiment, the discharge tube includes one or more openings along the length of the tube, or for example along the height of the discharge tube in the assembled state. In one embodiment, the one or more openings can be disposed at locations about the circumference of the discharge tube.

In one embodiment, the lubricant separator includes a flow director on the discharge tube. The flow director includes one or more surfaces that extend away from the outer dimension of the discharge tube. In one embodiment, the flow director is a flare like structure including a drip edge.

In one embodiment, the discharge tube is structurally secured at both ends.

In one embodiment, the inlets are on the same horizontal plane. In some embodiments, the inlets are on different horizontal planes. In some embodiments, the inlets are oriented at or about 90 to at or about 180 degrees relative to each other about the circumference of the shell. In some embodiments, the inlets have openings that are angled relative to a horizontal plane.

In one embodiment, and end of the discharge tube includes a plug. In one embodiment, the plug closes the end of the discharge tube.

### DRAWINGS

These and other features, aspects, and advantages of lubricant separators herein will become better understood when the following detailed description is read with reference to the accompanying drawings, wherein:

FIG. 1 is a side view showing external and internal features of an embodiment of a lubricant separator.

FIG. 2 is a perspective view of an embodiment of a lubricant separator.

FIG. 3 is a perspective view showing embodiments of internal features of the lubricant separator of FIG. 2.

FIG. 4A is a perspective view showing the lubricant separator of FIG. 2 implemented in a refrigeration or cooling system, such as for example a chiller, which as shown is an example of an air-cooled chiller.

FIG. 4B is a schematic view of a refrigeration or cooling system, such as for example a chiller, in which a lubricant separator herein may be implemented with a multiple compressor arrangement.

FIG. 4C is a schematic view of a refrigeration or cooling system, such as for example a chiller, in which a lubricant separator herein may be implemented with a single compressor arrangement with two or multiple discharge lines.

FIG. 5 is a side view showing external and internal features of an embodiment of a lubricant separator.

FIGS. 6A and 6B are views of one embodiment of a discharge tube which may be implemented in a lubricant separator design. FIG. 6A is a perspective view.

FIG. 6B is a side view showing external and internal features.

FIG. 7 is an outer view and inner view of one embodiment of a lubricant separator.

FIG. 8 is a schematic side view showing external and internal features of an embodiment of a lubricant separator.

FIG. 9 is a schematic side view showing external and internal features of an embodiment of a lubricant separator.

FIG. 10 is a schematic side view showing external and internal features of an embodiment of a lubricant separator.

FIG. 11 is a schematic side view showing external and internal features of an embodiment of a lubricant separator.

FIG. 12 is a schematic side view showing external and internal features of an embodiment of a lubricant separator.

FIGS. 13A and 13B are respective side and perspective views of an embodiment of a discharge tube for a lubricant separator and similar to the concept shown in FIG. 12.

FIG. 14 is a schematic side view showing external and internal features of an embodiment of a lubricant separator.

FIGS. 15A to 15E are side views of various embodiments of a lubricant separator. FIG. 15A shows an embodiment of external features of the lubricant separator design, and FIGS. 15B to 15E show embodiments of variations of the internal features of the lubricant separator design. FIG. 15E shows an embodiment of external and internal features of a lubricant separator design.

FIGS. 16A to 16D are embodiments of a lubricant separator showing another embodiment of an inlet configuration.

While the above-identified figures set forth particular embodiments of lubricant separators, other embodiments are also contemplated, as noted in the descriptions herein. In all cases, this disclosure presents illustrated embodiments of lubricant separators by way of representation but not limitation. Numerous other modifications and embodiments can be devised by those skilled in the art which fall within the scope and spirit of the principles of the lubricant separators described and illustrated herein.

### DETAILED DESCRIPTION

Embodiments disclosed herein relate generally to lubricant (e.g. oil) separators. In particular, apparatuses, systems and methods are directed to oil separators, such as for example cyclonic type oil separators, which may be implemented in fluid systems, such as for example in refrigeration or cooling systems and/or HVAC systems, which employ refrigerant as a working fluid. The lubricant separators herein may be employed for example in a fluid chiller (e.g. water chiller) with a screw or scroll compressor design, and such as may be used in a HVAC system. It will be appreciated that the lubricant separators herein may be implemented in fluid systems other than an HVAC, refrigeration, or cooling system, implemented in units other than a fluid chiller, implemented with fluids other than a lubricant (e.g. oil), and/or implemented with compressors other than a screw or scroll compressor.

Lubricant separators herein include various features that provide one or more of the advantages of reducing pressure losses, addressing local gas velocities which may contribute to entrainment of liquids, maintaining and/or improving oil separation (e.g. oil circulation rates), reducing the size of the lubricant separator, and/or reducing or minimizing costs of production.

For example, lubricant separators herein can provide a cost reduction of currently produced oil separators that are used, such as for example in systems that employ a screw compressor design. Lubricant separators herein can also provide cost containment on future systems, such as for example that may employ scroll compressor designs, incorporating an oil separator with a relatively high pressure (e.g. “high side”) oil sump, and which may also be used in certain screw compressor designs. Such lubricant separators herein can be implemented for example in a fluid chiller that has a compressor capacity, such as for example greater than 50 tons, where a high side oil sump may be employed. Lubricant separators herein can be implemented with various working fluids, including for example various refrigerants and blends thereof, including for example R134a and/or R410a or other refrigerants including for example relatively medium to high pressure refrigerants.

For example, current screw compressor designs employed in chillers such as for an HVAC system, have the oil separator between the compressor and condenser to separate oil from refrigerant gas. Such oil separators are designed with well over 6.00 inches of inside diameter for the shell (e.g. 12 inches, 10 inches, 8 inches and the like), which classifies them as pressure vessels requiring them to be code complying under standards set for example by the American Society of Mechanical Engineers (ASME). Lubricant separators herein can have an inner shell diameter that is less than 6.00 inches and can be shorter than 24-28 inches which is a typical height range of certain oil separators.

In one embodiment, the lubricant separator herein includes a shell with an inside diameter of less than 6.00 inches. In one embodiment, the lubricant separator is not an ASME rated pressure vessel due to for example the size of the inside diameter being within a certain dimension, e.g. less than 6.00 inches. In some cases, such a designed lubricant separator provides a significant cost advantage over ASME rated pressure vessels.

It will be appreciated that the lubricant separators herein may have shells with inside diameters at or greater than 6.00 inches. Generally, the lubricant separators herein can provide an advantage of a size reduction (e.g. shells with smaller inside diameters) relative to various application in which the lubricant separators herein may be implemented, including for example relatively smaller and relatively larger capacity applications.

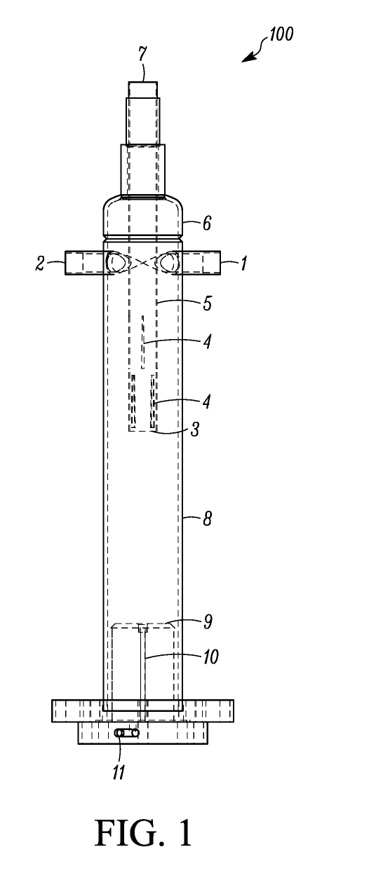

FIG. 1 is a side view showing external and internal features of an embodiment of a lubricant separator 100.

In the embodiment shown, the lubricant separator 100 has a shell 8 and a cap 6, which may be domed shaped. In the embodiment shown, the separator 100 has a twin inlet configuration, illustrated by inlets 1 and 2. Refrigerant gas and liquid oil enter through the inlets 1, 2. The separator 100 has a vapor outlet 7 and a liquid (e.g. lubricant) exit 11

In the embodiment shown, the inlets 1, 2 are located, positioned, or otherwise arranged tangentially on the perimeter of the shell 8. In some embodiments, the inlets 1, 2 may be sized, e.g. the inner diameter size, to allow for example a maximum inlet velocity. In some embodiments, the inlet size (e.g. inlet inner diameter) may be limited to a size so that the opening through the inlet(s) does not have a line of sight relative to a discharge tube 5 within the shell 8. For example, when looking through the inlets 1, 2, the discharge tube 5 is not in the line of sight, such as for example not visible through the inlets or is only partially or is minimally visible. In an embodiment, in looking through the opening of the inlet(s) there is no line of sight to the discharge tube. In an embodiment, in looking through the opening of the inlet(s) there is only a partial or minimal view of the discharge tube, where the majority of the discharge, such as for example substantially all of the discharge tube is out of sight.

The opening of the inlets, e.g. inlets 1, 2, being within the line of sight of the discharge tube 5 may in some cases degrade the oil separation efficiency, by potentially allowing oil to impinge on the discharge tube 5, rather than the shell 8 thereby risking oil entrainment with the vapor and into the discharge tube 5. It will be appreciated that the inlet size can be partially within the line of sight of the discharge tube without degrading the oil separation efficiency, for example in certain operating conditions such as when the local gas velocities are relatively low and/or in conditions where impingement of oil on the discharge tube is relatively less of a risk.

It will be appreciated that the discharge tube 5, or any discharge tube herein, may not be entirely out of the line of sight relative to the opening(s) of the inlet(s). For example, the discharge tube in some embodiments may be partially within the line of sight of the opening(s), such as for example where the majority of the discharge tube is out of the line of sight, or it is nearly out of sight from the opening(s) of the inlet(s).

Generally, it may be desired in certain circumstances to physically limit the size of the inlets 1, 2 to be suitably compact relative to a line of sight orientation with respect to the discharge tube 5. In some cases, the discharge tube may have a portion that is observable through the inlet(s), e.g. partially within the line of sight.

It will be appreciated that one inlet may be implemented, or more than two inlets may be implemented. The inlets can be positioned or located, such as for example at the same height or at different heights along the discharge tube 5, and can be oriented at the same angle or at different angles relative to horizontal. Generally, additional inlets can allow for additional fluid flow area while also reducing the risk of being in the line of sight relative to the discharge tube 5, and depending on their sizing.

In some embodiments where multiple inlets are employed, the inlets can be angled or otherwise oriented in different directions so that flow from one inlet does not disrupt the flow from another inlet. For example, the inlets may be angled somewhat downward in different directions. As one example, the inlets could be constructed, configured, and/or arranged to provide a flow resembling a double helix type flow, with angled inlets (e.g. not horizontal) facing different directions, and/or different flows.

It will also be appreciated that the inlets of the lubricant separators herein can be configured to support more than one compressor (e.g. two compressors for a twin inlet design, one inlet for each compressor), where the inlets can be sized and oriented to design a certain flow as desired and/or needed.

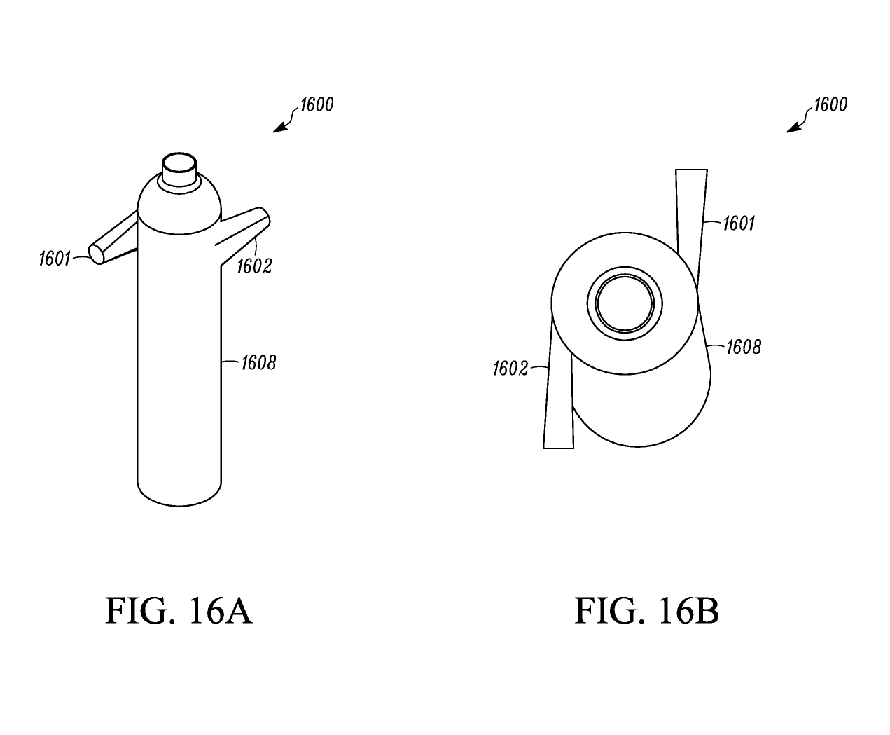

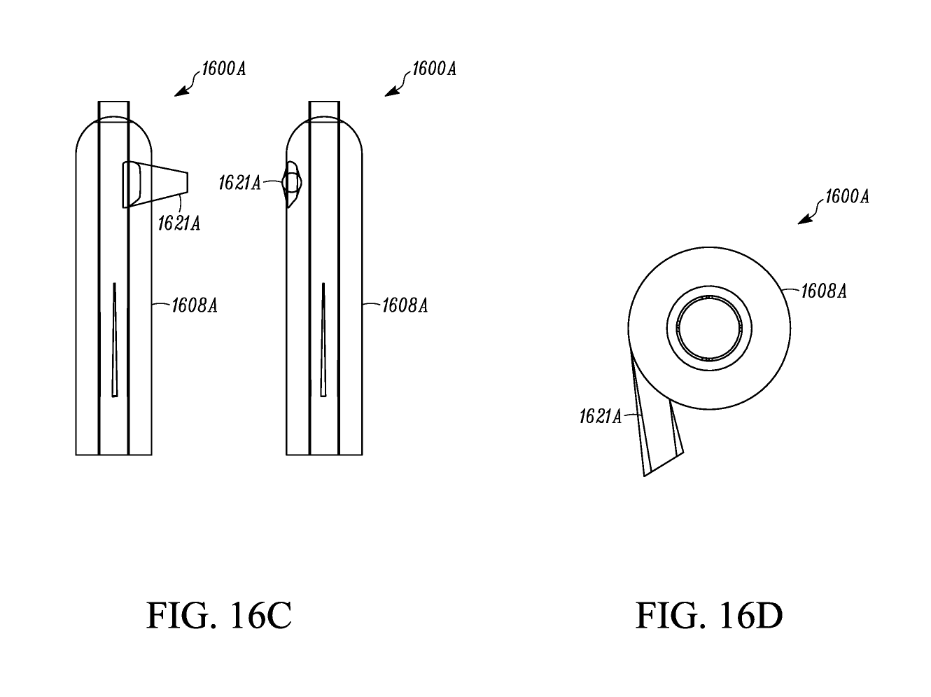

In some embodiments, the inlet(s) can have various geometries including geometries that vary through any given inlet. FIGS. 16A to 16D are embodiments of a lubricant separator (1600, 1600A) with inlets with varying geometries. FIGS. 16A and 16B show inlets 1601 (1601A) and 1602 (1602A) connected to the shell 1608 (1608A). The inlets 1601 (1601A), 1602 (1602A) have a geometry that tapers as the inlets 1601 (1601A), 1602 (1602A) approach and access the inside of the shell 1608 (1608A). FIGS. 16C and 16D show the separator 1600A, for example with an inlet 1621A that has a varying geometry. In the embodiment shown, the inlet 1621A has a relatively round or circular entry and transitions to a relatively elongated shape (e.g. oval or oblong like shape) as the inlet 1621A approaches and accesses the inside of the shell 1608. In the embodiment shown in FIGS. 16C and 16D, one inlet is shown however it will be appreciated that multiple inlets may be used with such a configuration, e.g. as in FIGS. 16A and 16B.

In the embodiment shown in FIGS. 16C and 16D, a single inlet may be used, where the single inlet may be contoured from relatively round to relatively elongated, similar to an elongated slot, and where the elongated slot can have a similar cross-sectional area relative to the round contour of the inlet, which may connect to a similarly shaped entering round discharge line from a compressor.

With further reference to FIG. 1, as the gas and liquid “swirls” around the separator 100, the higher momentum of liquid droplets (in this case oil) cause the liquid to impinge onto the inside surface of the shell 8, where they may adhere. The refrigerant gas continues swirling around and down the separator 100.

In the embodiment shown, the discharge tube 5 is positioned relatively centered within the inner diameter of the shell 8 and receives the refrigerant gas.

The discharge tube 5 is shown as a cylindrical component. However, it will be appreciated that the discharge tube 5 is not limited to a cylindrical shape, and can be suitably constructed as an outlet component, such as an outlet pipe which may be any shape or design. It will also be appreciated that the discharge tube 5 height (e.g. length) can vary.

In the embodiment shown, the discharge tube 5 includes openings 4 to receive the refrigerant gas.

In some embodiments, the openings 4 are on the side of the discharge tube 5, and can be in various numbers, shapes, sizes, arrangements, patterns, locations and the like. For example, the openings can 4 be round-like or circular, square or rectangular-like, triangular, trapezoidal, other polygonal shape, or other suitable shapes. The openings 4 can be sized and shaped depending on a flow rate/internal pressure of the type of system in which the separator 100 is employed. It will also be appreciated that the openings 4 can be constructed, configured, and/or arranged to meter the flow of vapor through the discharge tube 5 and exiting the outlet 7. It will also be appreciated that the number, placement, and/or geometry of the openings 4 can be pre-determined to achieve a uniform flow rate entering the discharge tube 5 along the dimensions of the openings.

In some examples, such as shown in FIG. 1, the opening(s) 4 are constructed as relatively slot-like features that extend in a relatively vertical direction of the height of the discharge tube 5.

The openings 4 are constructed, configured, and/or arranged to in certain circumstances reduce local gas velocities and/or minimize local gas velocities within the main separator shell, such as for example that may be observed along and/or proximate the discharge tube. High local gas velocities can have a tendency to re-entrain liquid, e.g. oil, thereby decreasing the efficiency of the separator and/or have undesired pressure drop.

In some examples such as the embodiment shown in FIG. 1, there is a plurality of openings 4 constructed and configured as slots. As shown, the slots are positioned relatively circumferentially around the discharge tube 5 to facilitate a relatively well behaved, smooth turn of the gas flow into the discharge tube, while reducing local gas velocities and reducing the potential for liquid oil entrainment into the discharge tube.

The slots help to distribute the flow of gas over a wider area, e.g. spread it out along the length of the discharge tube 5. The slots help to provide a more gradual gas flow, rather than requiring all of the flow to move down the discharge tube 5, and turn sharply to move vertically upward into the discharge tube (e.g. at opening or port 3).

The slots help to reduce pressure losses, while reducing or avoiding liquid (e.g. oil) entrainment into the discharge tube, or other local effects and potential sudden tendency carryover phenomena. Such local effects may be conditions of relatively high velocity in a low pressure region, which can cause stripping, e.g. leading to carryover over liquids into the discharge tube 5.

The use of the openings (e.g. slots) help the flow to approach and enter the discharge tube 5 at relatively lower velocities, which can be helpful due to a relatively close distance from discharge tube 5 and the inner surfaces of the shell 8.

Generally, the summed area of the openings 4, e.g. slots, provides a strategic approach to increasing the cross-sectional flow area compared for example to the cross-sectional flow area of a discharge tube with only an open bottom end (e.g. at 3). The openings 4 can also provide advantages of relatively lower pressure drop, e.g. pressure losses through the lubricant separator 100.

It will be appreciated that the openings 4, e.g. slots as shown in FIG. 1, are intentionally sized and positioned to manage the flow of refrigerant gas as it leaves the main swirling (e.g. cyclonic) flow within the shell 8 of the lubricant separator 100 and flows into the discharge tube 5.

The use of the openings 4 for gas to enter the discharge tube along its side wall in addition to or instead of the opening 3 or port at the bottom of the discharge tube 5. Advantages of doing this include for example being able to make the oil separator 100 overall, significantly smaller, e.g. by reducing the inner diameter of the shell 8, such as for example to 6.00 inches or less. The vessel material cost is lower, and becomes a non-ASME component which also reduces production cost. For example, as high as 50% cost reduction may be observed relative to for example oil separators with an 8″ or 10″ or 12″ inner diameter.

In some embodiments, the discharge tube 5 can also have an opening 3 at the lower end of the discharge tube, such as for example through the end and not along the vertical direction of the discharge tube. In an embodiment, it will be appreciated that side openings, e.g. 4, along the length of the discharge tube 5 may not be implemented, as shown and described with respect to further embodiments below.

Refrigerant gas can leave the lubricant separator through the outlet or port 7 of the discharge tube 5.

Oil drains downward along the inside surfaces of the side wall of the shell 8. In some embodiments, the oil flows past a plate 9 and into a sump area below the plate 9. In some embodiments, such as shown in FIG. 1, the sump area includes one or more anti-swirl plates 10. Oil can exit the outlet 11 or port of the shell 8.

In another embodiment, the opening or port at the bottom of the discharge tube may not be open. For example, the opening may be manufactured as closed or provided with a plug structure. In such an embodiment, the refrigerant gas would enter the discharge tube through other openings, e.g. on the side of the tube, such as for example the slots shown in FIG. 1.

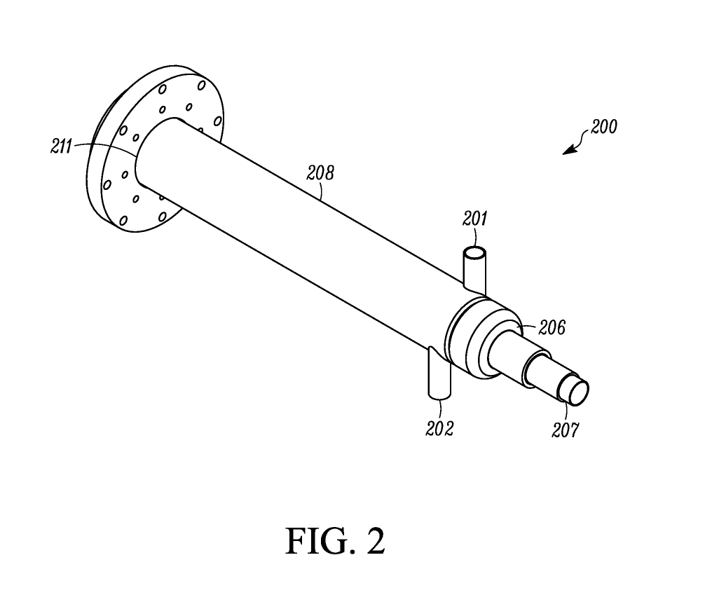

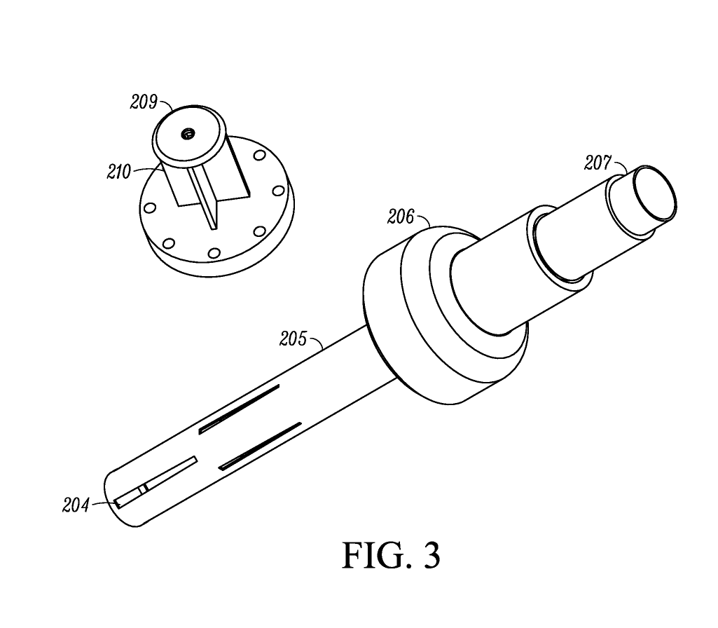

FIG. 2 is a perspective view of an embodiment of a lubricant separator 200. The lubricant separator 200 is similar to the lubricant separator 100 and shows external features of the twin outlets 201, 202, the shell 208, the outlet 207, and areas where the oil exit 211 is located. FIG. 3 is a perspective view showing embodiments of internal features of the lubricant separator 200 of FIG. 2. As shown, the lubricant separator 200, similar to 100, includes a domed cap 206, the discharge tube 205 with opening 204 (e.g. slots). Also shown is plate 209, which can act as a divider between the sump area below the plate 209 (e.g. as in plate 9 in FIG. 1). The plate 209 in some embodiments, such as shown in FIG. 3, is connected to one or more anti-swirl plates 210.

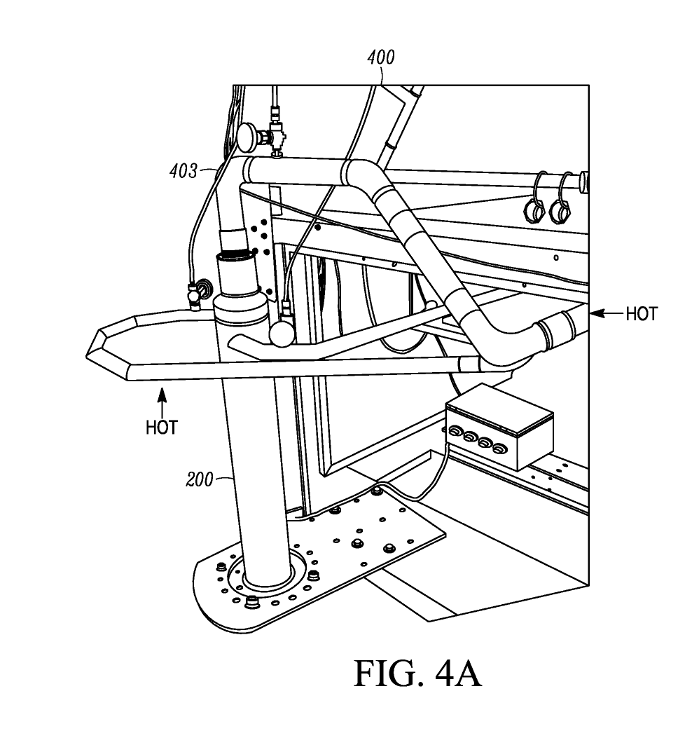

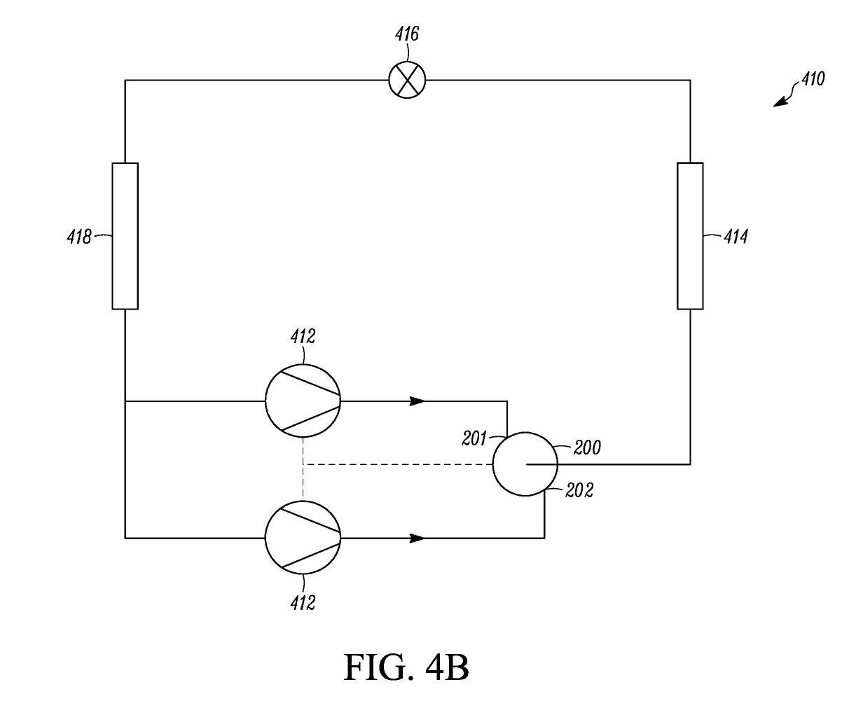

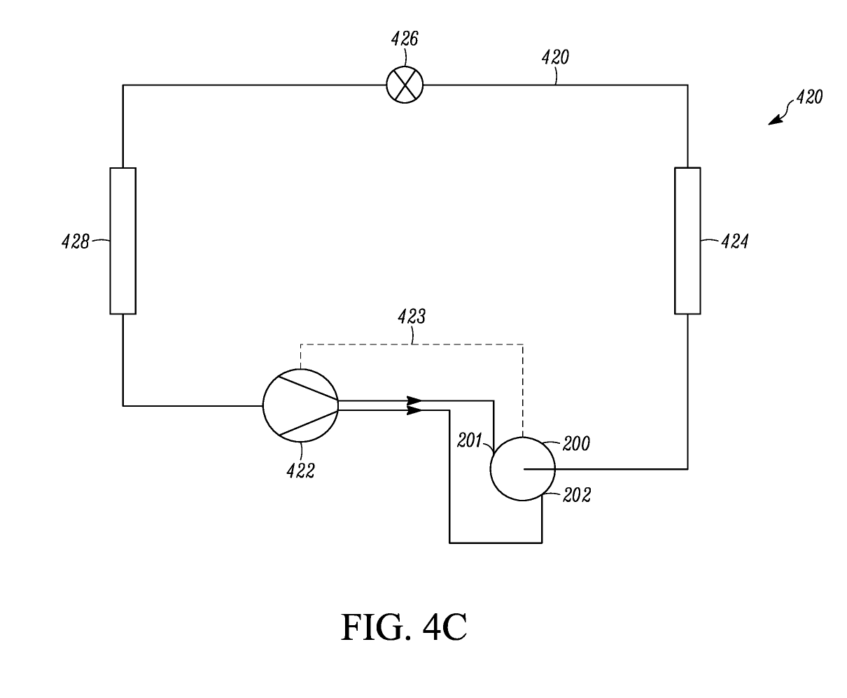

FIG. 4A is a perspective view showing the lubricant separator 200 of FIG. 2 implemented in a chiller 400, and where as shown the discharge line 403 exits the outlet of the lubricant separator 200 and above the twin inlet design.

FIGS. 4B and 4C show schematic views of systems in which a lubricant separator herein, e.g. 200, may be implemented. For example, FIG. 4B is a schematic view of a refrigeration or cooling system 410, such as for example a chiller, in which a lubricant separator, e.g. 200, may be implemented with a multiple compressor (two compressors 412) arrangement. As shown, the system 410 includes the compressors 412, each having a discharge line in fluid connection with the respective inlets 201, 202 of the lubricant separator 200. A return line (see dashed line) returns separated lubricant back to the compressors 412. Also shown are a condenser 414, an expansion device 416, and an evaporator 418 as typically present in a refrigeration or cooling system.

In another example, FIG. 4C is a schematic view of a refrigeration or cooling system 420, such as for example a chiller, in which a lubricant separator herein, e.g. 200, may be implemented with a single compressor arrangement 422 with two or multiple discharge lines. As shown, the system 420 includes the compressor 422, having multiple discharge lines, for example two lines as shown, which are in fluid connection with the respective inlets 201, 202 of the lubricant separator 200. A return line (see dashed line) 423 returns separated lubricant back to the compressor 412. Also shown are a condenser 424, an expansion device 426, and an evaporator 428 as typically present in a refrigeration or cooling system.

It will be appreciated that any of the lubricant separators herein may be implemented with any of the systems 400, 410, and 420.

In some embodiments, the discharge tube 5, 205 may be shortened or may be extended further downward, such as for example to a plate (e.g. plate 9, 209) relative to a sump area. The plate in some embodiments may include an alignment feature, such as for example to locate and/or center the discharge tube within the shell 8. The alignment feature, for example can be a pin and/or suitable key structure to receive the end of the discharge tube. In such an embodiment of implementing an alignment feature, the end of the discharge tube may be closed.

In such a configuration, the extension of the discharge tube 5, 205 can address or avoid potential vibration or mechanical issues, as the discharge tube would be further supported by additional structure, e.g. plate 9, 209.

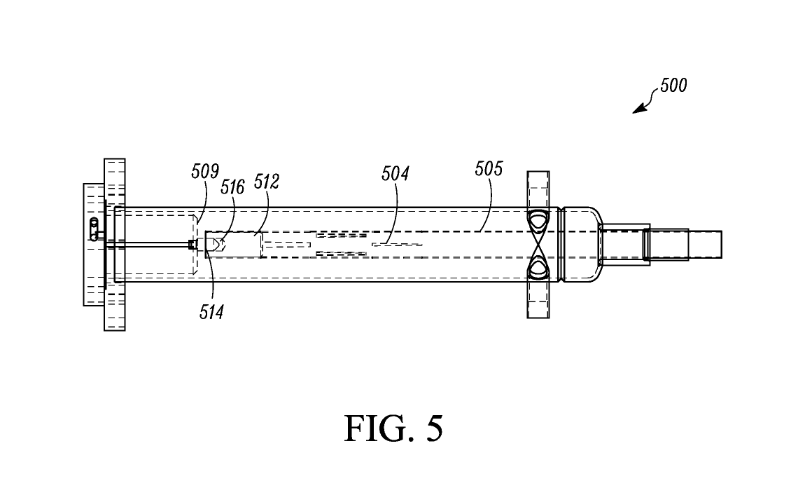

FIG. 5 is a side view showing external and internal features of an embodiment of a lubricant separator 500, where the discharge tube 505 is extended to a plate 509. Like features relative to FIGS. 1 to 4 are not referred to in FIG. 5. The lubricant separator 500 includes the discharge tube 505 with openings 504. In the embodiment shown, one end or the bottom of the discharge tube 505 includes a plug 512. The plug 512 has an entry 516 to connect to and receive a pin 514 disposed on the plate 509. It will be appreciated that the specific structure as shown in FIG. 5 is merely exemplary, and the configuration to connect the discharge tube 50 5 to the plate 509 can be any suitable connection structure. For example, the discharge tube 505 may include the pin, and the plate 509 may have the entry or recess. It will also be appreciate that a pin and recessed plug structure may not be used. The connection structure can also provide an alignment, such as for example, centering the discharge tube within the shell of the lubricant separator 500.

In the embodiment shown, the discharge tube 505 may be closed at the end where the plug 512 is located. However, it will be appreciated that the plug or connective structure on the discharge tube 505 may not be fully closed and could have or leave opening(s) for vapor to enter the discharge tube 5 from the end (e.g. the bottom when installed).

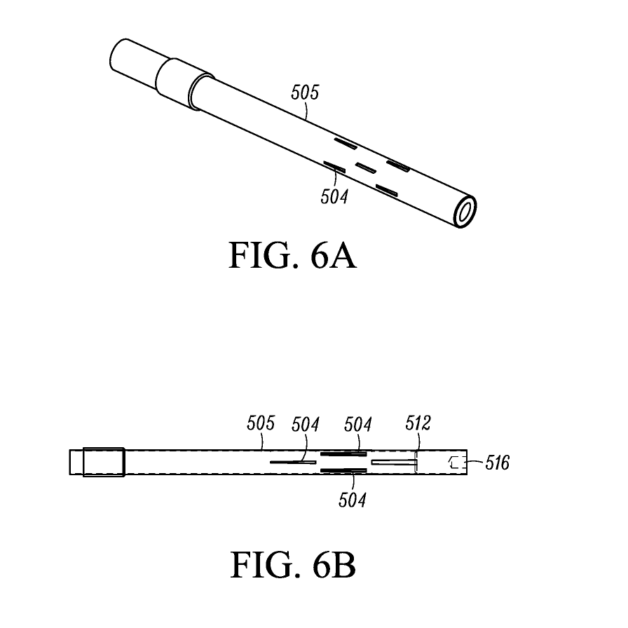

FIGS. 6A and 6B are views of an embodiment of a discharge tube 505 which may be implemented in a lubricant separator design. The discharge tube 505 is similar to what is shown in FIG. 5, and includes a plug 512 and entry 516 for a pin, e.g. pin 514 on plate 509 in FIG. 5, to enter and connect with the discharge tube 505. The plug 512 may be brazed together with the discharge tube 505 and may be flush with the end thereof. FIG. 6A is a perspective view of the discharge tube 505. FIG. 6B is a side view of the discharge tube 505 showing the external and internal features. A connection structure, such as threads may be disposed proximate the other end of the discharge tube relative to the end where the plug 512 is located. The connection structure, e.g. threads, can allow for the discharge tube 505 to be connected to a cap and/or outlet of a lubricant separator (e.g. 500 in FIG. 5). This end may also be brazed with the outlet.

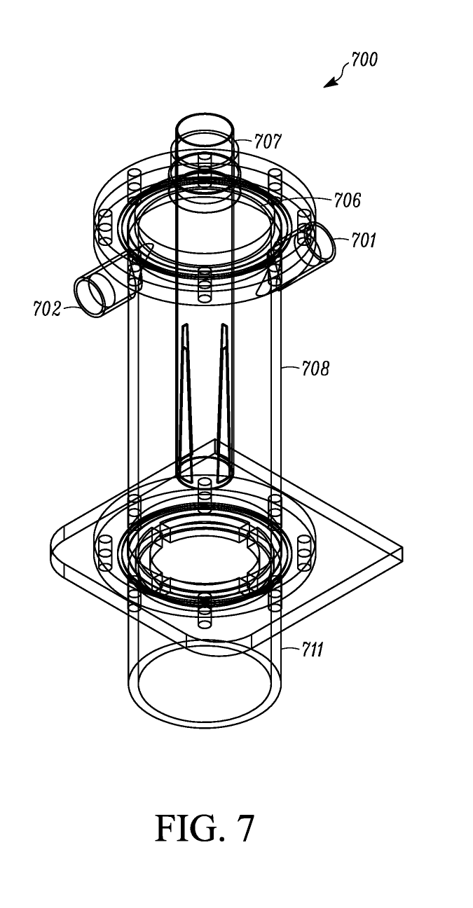

FIG. 7 is an outer view and inner view of one embodiment of a lubricant separator 700. As shown, the lubricant separator 700 includes a shell 708, inlets 701, 702, a cap 706, which may be a domed cap, and an outlet 707. The oil exit may be from the bottom 711. For purposes of illustration, also shown through the shell 708 and outlet 707 is an example of the discharge tube with openings.

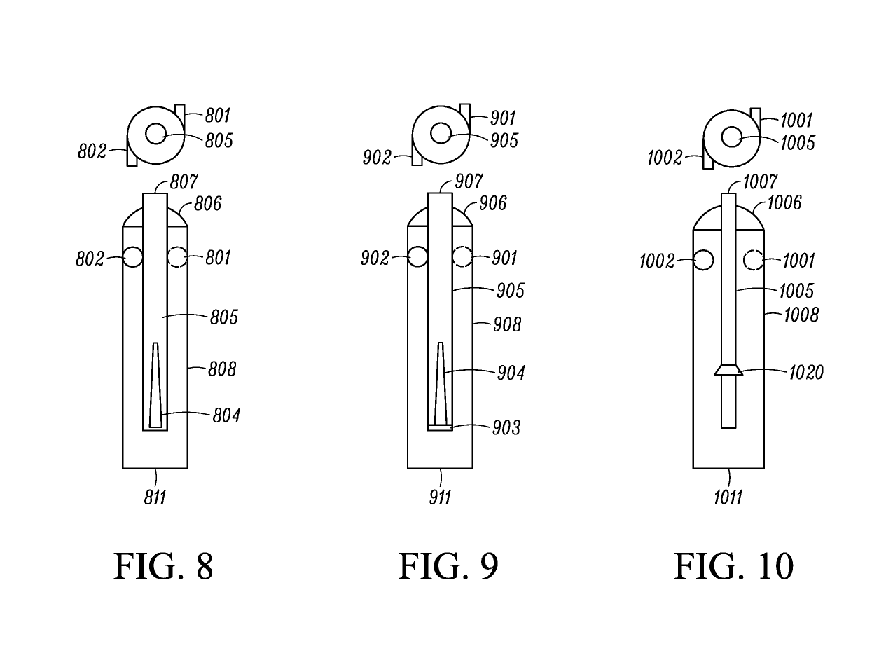

FIGS. 8 to 12 show various embodiments of external and internal features for a lubricant separator, and which can be consistent with the external view of the separator 700 shown in FIG. 7.

FIG. 8 is a side view showing external and internal features of an embodiment of a lubricant separator 800. As shown, the lubricant separator 800 includes a shell 808, inlets 801, 802, which in this embodiment may be constructed to have no line of sight or a minimal line of sight to a discharge tube 805, e.g. the large majority of the discharge tube 805 is not within the line of sight of the inlets 801, 802. The lubricant separator 800 also has a cap 806, which may be a domed cap, and an outlet 807. The oil exit may be from the bottom 811. The discharge tube 805 has openings 804 (e.g. one slot is shown). In some embodiments, the inner diameter of the shell 808 can be at or about or under 6.00 inches (e.g. 5.9 inches), and the height can be at or about 17 inches (e.g. 17.2 inches). The inlets 801, 802, can be about oriented relatively at or about 180 degrees from each other and on the same horizontal plane, but this is merely exemplary as other angles may be used and the inlets may be on different planes, and which may be dependent upon the number of inlets used. The inlets 801, 802 may have an inner diameter of at or about 1⅝ inches or they may both or separately be sized differently. The discharge tube 805 can have an outer diameter of at or about 1.625 inches to at or about 2.5 inches, an inner diameter of at or about 1.505 inches to at or about 2.37 inches. The openings 804 can be slots which have a taper, e.g. 0.25×0.75 inch, and have a length of at or about 7.25 or they may all or separately be sized differently. The separator 800 may have four slots located about the circumference of the discharge tube 805. The end of the discharge tube 805 proximate the bottom may be open to allow entry of vapor into the discharge tube 805 to the outlet 807. It will be appreciated that the specific dimensions above and numbers of openings are not meant to be limiting and may vary.

FIG. 9 is a side view showing external and internal features of an embodiment of a lubricant separator 900. As shown, the lubricant separator 900 includes a shell 908, inlets 901, 902, which in this embodiment may be constructed to have no line of sight or a minimal line of sight to a discharge tube 905, e.g. the large majority of the discharge tube 905 is not within the line of sight of the inlets 901, 902. The lubricant separator 900 also has a cap 906, which may be a domed cap, and an outlet 907. The oil exit may be from the bottom 911. The discharge tube 905 has openings 904 (e.g. one slot is shown). In some embodiments, the inner diameter of the shell 908 can be at or about or under 6.00 inches (e.g. 5.9 inches), and the height can be at or about 17 inches (e.g. 17.2 inches). The inlets 901, 902, can be about oriented relatively at or about 180 degrees from each other and on the same horizontal plane, but this is merely exemplary as other angles may be used and the inlets may be on different planes, and which may be dependent upon the number of inlets used. The inlets 901, 902 may have an inner diameter of at or about 1⅝ inches or they may both or separately be sized differently. The discharge tube 905 can have an outer diameter of at or about 1.625 inches to at or about 2.5 inches, an inner diameter of at or about 1.505 inches to at or about 2.37 inches. The openings 904 can be slots which have a taper, e.g. 0.25×0.75 inch, and have a length of at or about 7.25 or they may all or separately be sized differently. The separator 900 may have four slots located about the circumference of the discharge tube 905. The end of the discharge tube 905 proximate the bottom may be closed to not allow entry of vapor from the end of the discharge tube 905 to the outlet 907. It will be appreciated that the specific dimensions above and numbers of openings are not meant to be limiting and may vary.

FIG. 10 is a side view showing external and internal features of an embodiment of a lubricant separator 1000. As shown, the lubricant separator 1000 includes a shell 1008, inlets 1001, 1002, which in this embodiment may be constructed to have no line of sight or a minimal line of sight to a discharge tube 1005, e.g. the large majority of the discharge tube 1005 is not within the line of sight of the inlets 1001, 1002. The lubricant separator 1000 also has a cap 1006, which may be a domed cap, and an outlet 1007. The oil exit may be from the bottom 1011. The dimensions of the separator 1000 may be similar to those dimensions described above with respect to FIGS. 8 and 9. The end of the discharge tube 1005 proximate the bottom may be open to allow entry of vapor into the discharge tube 1005 to the outlet 1007.

FIG. 10 also shows a flow director 1020. Generally, flow directors herein in some embodiments, are disposed on the discharge tube, and have one or more surfaces that extend away from the outer surface of the discharge tube. For example, the flow directors herein may have one or more surfaces that are perpendicular to the outer surface of the discharge tube (e.g. set at about 90 degrees) and/or may include surfaces that have an angle relative to the outer surface of the discharge tube, such as for example angled downward away from the inlet(s) or toward the sump area and exit.

It will be appreciated that when using the flow director, the inlet(s) used in a lubricant separator may be constructed to have some (e.g. minimal) line of sight relative to the discharge tube. It will also be appreciated that flow directors herein may be implemented in separators with a single or multiple inlets in various configurations and geometries, and/or in separators with or without openings (e.g. slots) along the outer side of the discharge tube.

In the example shown in FIG. 10, the flow director 1020 may be angled away relative to the outer surface of the discharge tube 1005. The specific structure of the flow director 1020 is not intended to be limiting. In the example shown, the flow director can be a flare-like structure, cone-like structure, a bell shaped structure, or other suitable structure which may provide an angled surface(s) relative to the outer dimension of the discharge tube 1005.

Flow directors herein may be useful to help prevent entrainment of liquid (e.g. oil) and carryover into the discharge tube and from exiting the outlet. Flow directors herein provide surfaces that extend away from the outer dimension of the discharge tube. Flow directors herein at their distal end (i.e. away from the outer dimension of the discharge tube) have a drip edge for liquid (e.g. oil) to drip and flow downward to the sump area of the separator. The drip edge is generally spaced away from the discharge tube so as to direct liquid away from the discharge tube. The spacing of the drip edge may vary depending on the design. It will also be appreciated that the location of the flow director on the height of the discharge can vary.

Flow directors herein can be useful in conditions of relatively low capacity and/or low flow rate, so as to reduce and/or minimize the risk of liquid oil being entrained with the vapor through the discharge tube and outlet.

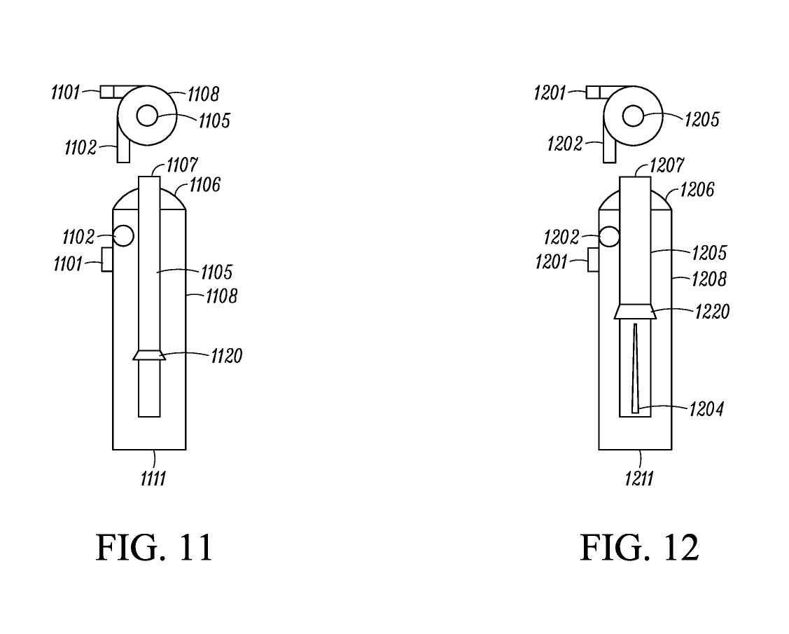

FIG. 11 is a side view showing external and internal features of an embodiment of a lubricant separator 1100. As shown, the lubricant separator 1100 includes a shell 1108, inlets 1101, 1102, which in this embodiment may be constructed to have no line of sight or a minimal line of sight to a discharge tube 1105, e.g. the large majority of the discharge tube 1105 is not within the line of sight of the inlets 1101, 1102. In the embodiment shown, the inlets 1101 and 1102 are not on the same horizontal plane and are oriented about 90 degrees relative to each other, which may provide improved oil circulation rates (e.g. less than or equal to the 180 degree orientation). The lubricant separator 1100 also has a cap 1106, which may be a domed cap, and an outlet 1107. The oil exit may be from the bottom 1111. In the example shown, the discharge tube 1105 (as with discharge tube 1005) does not have openings on the side of the discharge tube. The dimensions of the separator 1100 may be similar to those dimensions described above with respect to FIGS. 8 and 9. The end of the discharge tube 1105 proximate the bottom may be open to allow entry of vapor into the discharge tube 1105 to the outlet 1107.

FIG. 11 also shows a flow director 1120 similar to FIG. 10.

FIG. 12 is a side view showing external and internal features of an embodiment of a lubricant separator 1200. As shown, the lubricant separator 1200 includes a shell 1208, inlets 1201, 1202, which in this embodiment may be constructed to have no line of sight or a minimal line of sight to a discharge tube 1205, e.g. the large majority of the discharge tube 1205 is not within the line of sight of the inlets 1201, 1202 In this embodiment, the inlets 1201, 1202 are oriented about 90 degrees relative to each other, which may provide improved oil circulation rates (e.g. less than or equal to the 180 degree orientation). In the embodiment shown, the inlets 1201 and 1202 are not on the same horizontal plane. The lubricant separator 1200 also has a cap 1206, which may be a domed cap, and an outlet 1207. The oil exit may be from the bottom 1211. The discharge tube 1205 has openings 1204 (e.g. one slot is shown). The dimensions of the separator 1200 may be similar to those dimensions described above with respect to FIGS. 8 and 9. The end of the discharge tube 1205 proximate the bottom may be open to allow entry of vapor into the discharge tube 1205 to the outlet 1207.

FIG. 12 also shows a flow director 1220 similar to FIG. 10. In the embodiment shown, the flow director 1220 is disposed above the opening 1204.

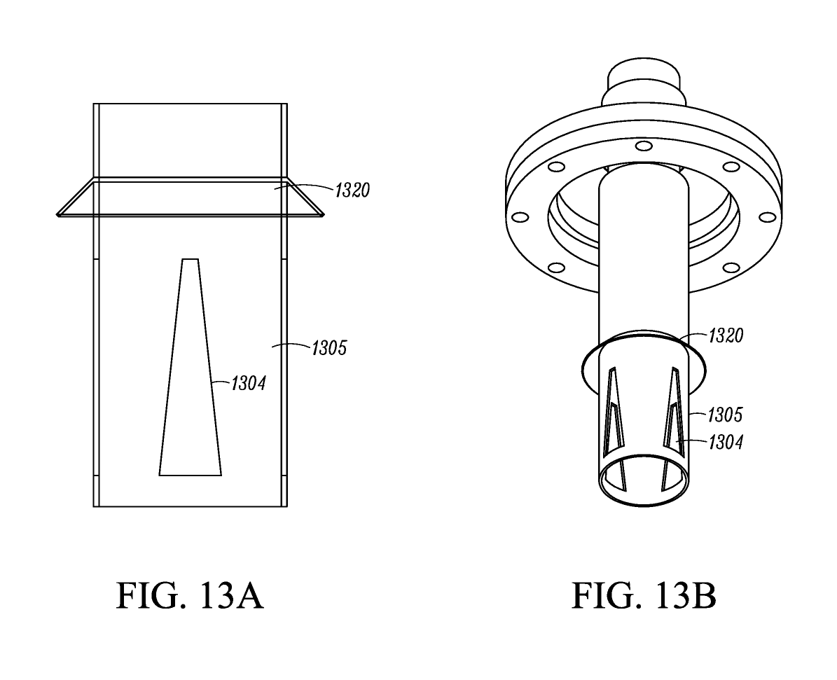

FIGS. 13A and 13B are respective side and perspective views of an embodiment of a discharge tube 1305 for a lubricant separator and similar to the concept shown in FIG. 12. The discharge tube 1305 has openings 1304, where a flow director 1320 is disposed above the openings 1304.

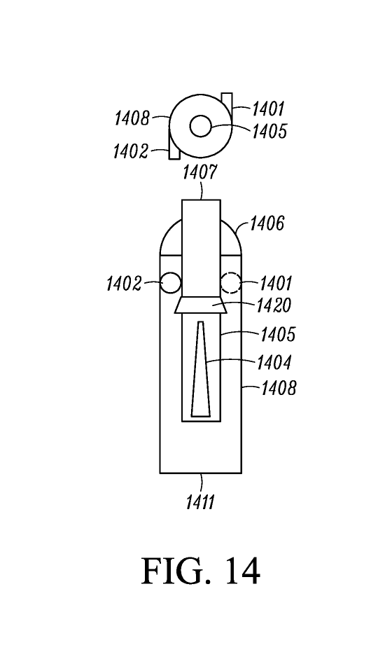

FIG. 14 is a side view showing external and internal features of an embodiment of a lubricant separator 1400. The lubricant separator 1400 is depicted as a scaled up version for example relative to the earlier lubricant separators described above. For example, the lubricant separator 1400 may be implemented in a chiller designed for 250 ton capacity or above.

As shown, the lubricant separator 1400 includes a shell 1408, inlets 1401, 1402, which in this embodiment may be constructed to have no line of sight or a minimal line of sight to a discharge tube 1405, e.g. the large majority of the discharge tube 1405 is not within the line of sight of the inlets 1401, 1402. In the embodiment shown, the inlets 1401, 1402 are on the same horizontal plane and are oriented about 180 degrees relative to each other. The lubricant separator 1400 also has a cap 1406, which may be a domed cap, and an outlet 1407. The oil exit may be from the bottom 1411. The discharge tube 1405 has openings 1404 (e.g. one slot is shown). The dimensions of the separator 1400 may be different from those dimensions described above for example with respect to FIGS. 8 and 9. For example, the inner diameter of the shell 1408 may be at or about 12.0 inches, the height may be at or about 16.6 inches (above the baffle), the inlet diameter may be at or about 3⅛ inches. The discharge tube may have an outer diameter of at or about 4.5 inches, an inner diameter of at or about 3.825 inches. The end of the discharge tube 1405 proximate the bottom may be open to allow entry of vapor into the discharge tube 1405 to the outlet 1407. It will be appreciated that the specific dimensions above and numbers of openings are not meant to be limiting and may vary.

FIG. 14 also shows a flow director 1420. In the embodiment shown, the flow director 1420 is disposed above the opening 1404.

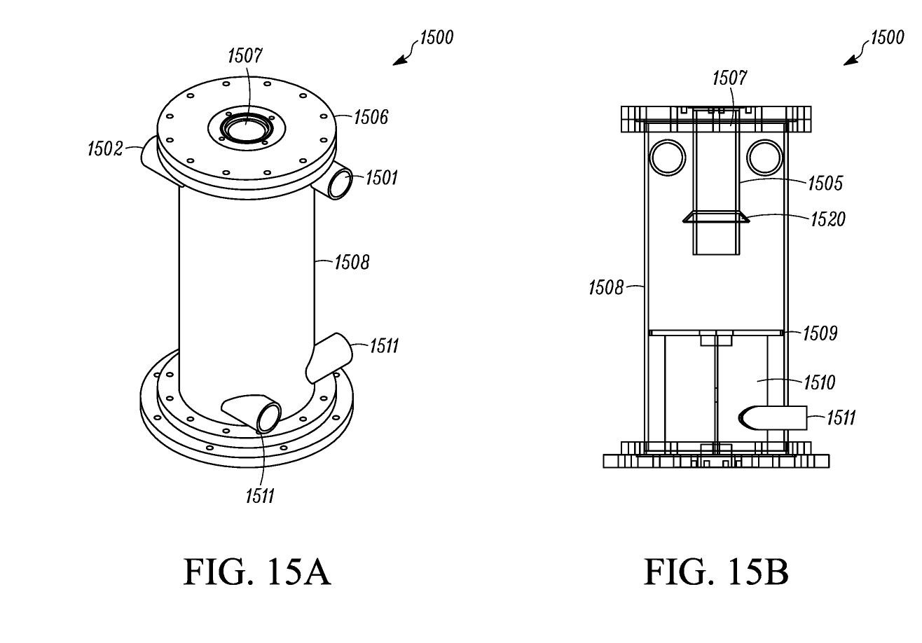

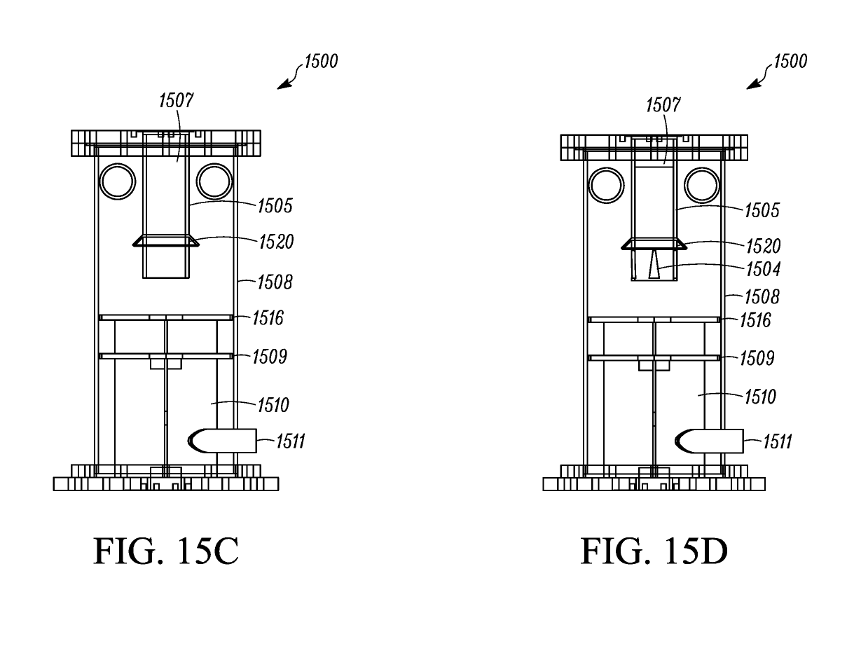

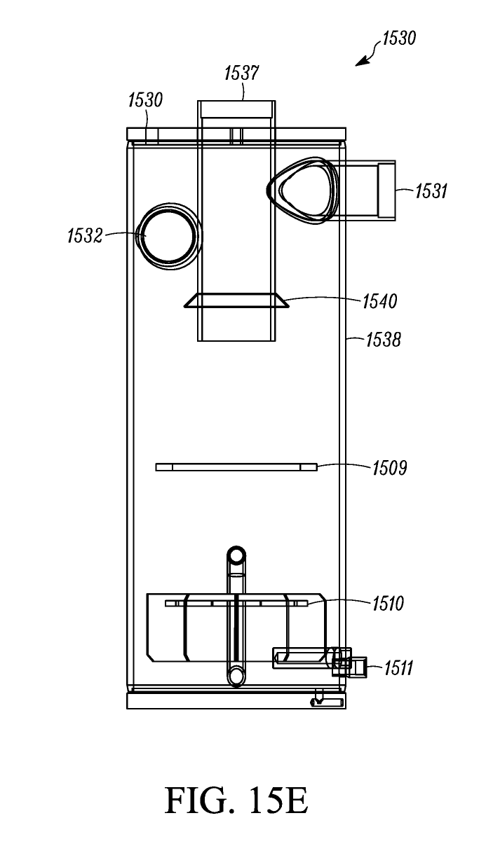

FIGS. 15A to 15D are side views of various embodiments of a lubricant separator. FIG. 15A shows an embodiment of external features of the lubricant separator design, and FIGS. 15B to 15D show embodiments of variations of the internal features of the lubricant separator design. The lubricant separator 1500 is depicted as a scaled up version for example relative to the earlier lubricant separators described above. For example, the lubricant separator 1500 may be implemented in a chiller designed for 250 ton capacity or above.

As shown, the lubricant separator 1500 includes a shell 1508, inlets 1501, 1502, which in this embodiment may be constructed to have no line of sight or a minimal line of sight to a discharge tube 1505, e.g. the large majority of the discharge tube 1505 is not within the line of sight of the inlets 1501, 1502. In the embodiment shown, the inlets 1501, 1502 are on the same horizontal plane and are oriented about 90 degrees relative to each other as shown in this example. The lubricant separator 1500 also has a cap 1506, which may be a removable cover, and an outlet 1507. The oil exit may be from the bottom 1511, and which may include a removable cover. As shown in FIG. 15D, the discharge tube 1505 has openings 1504 (e.g. one slot is shown). The dimensions of the separator 1500 may be different from those dimensions described above for example with respect to FIGS. 8 and 9 and 14. For example, the inner diameter of the shell 1508 may be at or about 14.0 inches, and the height may vary as well as the diameters of the inlets and the discharge tube. The end of the discharge tube 1505 proximate the bottom may be open to allow entry of vapor into the discharge tube 1505 to the outlet 1507. It will be appreciated that the specific dimensions above and numbers of openings are not meant to be limiting and may vary.

FIGS. 15B to 15D also show a flow director 1520. In the embodiment shown in FIG. 15D, the flow director 1520 is disposed above the opening 1504. FIG. 15B also shows a plate 1509, which may be a divider where the sump area is located below the plate 1509. One or more anti-swirl plates 1510 may be disposed under the plate 1509. It will be appreciated that the position of plate 1509 can vary. In some embodiments, for example such as shown in FIGS. 15C and 15D, a raised plate 1516 may be included above the plate 1509 or replace the plate 1509, for example to vary the divider plate location.

FIG. 15E shows an embodiment of external and internal features of a lubricant separator 1530 design. As shown, the lubricant separator 1530 includes a shell 1538, inlets 1531, 1532 which in this embodiment may be constructed to have no line of sight or a minimal line of sight to a discharge tube and outlet 1537, e.g. the large majority of the discharge tube is not within the line of sight of the inlets 1531, 1532. In the embodiment shown, the inlets 1531 and 1532 are not on the same horizontal plane and are oriented at or about 90 degrees relative to each other, which may provide improved oil circulation rates (e.g. less than or equal to the 180 degree orientation). The lubricant separator 1530 also has a cap, which may be a removable cover. The oil exit may be from the bottom 1511. In the example shown, the discharge tube does not have openings on the side of the discharge tube. The end of the discharge tube proximate the bottom may be open to allow entry of vapor into the discharge tube to the outlet 1107. FIG. 15E also shows a flow director 1540 similar to FIGS. 15B to 15D.

In an embodiment, the lubricant separator 1530 may have one or more of a plate 1509 to separate from a sump area, and/or one or more anti-swirl plates 1510 in the sump area. Lubricant, e.g. oil, can exit through the outlet 1511.

### Aspects

Aspects—any of aspects 1 to 15 may be combined with any of aspects 16 to 18, aspect 16 may be combined with aspects 17 or 18, and aspect 17 may be combined with aspect 18.

1. A lubricant separator includes a shell, a fluid inlet, a vapor outlet, a liquid outlet, and a discharge tube within the shell.

2. The lubricant separator of aspect 1, wherein the fluid inlet comprises multiple inlets that have openings such that the discharge tube is out of sight relative to the openings of the inlet.

3. The lubricant separator of aspect 1, wherein the fluid inlet comprises multiple inlets that have openings such that a majority of the discharge tube is out of sight relative to the openings of the inlets.

4. The lubricant separator of aspect 1, wherein the discharge tube includes one or more openings along the length of the tube, or for example along the height of the discharge tube in the assembled state.

5. The lubricant separator of aspect 4, wherein the one or more openings can be disposed at locations about the circumference of the discharge tube.

6. The lubricant separator of any one of aspects 1 to 5, further comprising a flow director on the discharge tube.

7. The lubricant separator of aspect 6, wherein the flow director includes one or more surfaces that extend away from the outer dimension of the discharge tube.

8. The lubricant separator of aspect 6 or 7, wherein the flow director is a flare like structure including a drip edge.

9. The lubricant separator of any one of aspects 1 to 8, wherein the discharge tube is structurally secured at both ends.

10. The lubricant separator of any one of aspects 1 to 9, wherein the inlets are on the same horizontal plane.

11. The lubricant separator of any one of aspects 1 to 9, wherein the inlets are on different horizontal planes.

12. The lubricant separator of any one of aspects 1 to 11, wherein the inlets are oriented at or about 90 to at or about 180 degrees relative to each other about the circumference of the shell.

13. The lubricant separator of any one of aspects 1 to 12, wherein the inlets have openings that are angled relative to a horizontal plane.

14. The lubricant separator of any one of aspects 1 to 13, wherein an end of the discharge tube includes a plug.

15. The lubricant separator of any one of aspects 1 to 14, wherein the plug closes the end of the discharge tube.

16. A chiller including the lubricant separator of any one of aspects 1 to 15.

17. A cooling or refrigeration system including the lubricant separator of any one of aspects 1 to 16.

18. A method of directing fluid flow through a lubricant separator of any one of aspects 1 to 17.

1. A cyclonic lubricant separator comprising:
a shell;
a fluid inlet to receive a fluid, the fluid including refrigerant vapor and lubricant, the fluid inlet configured to receive the fluid and direct the fluid into the shell and to direct the fluid to swirl inside the shell;
a vapor outlet;
a liquid outlet to exit lubricant,
a discharge tube within the shell, the discharge tube in fluid communication with the fluid inlet and the vapor outlet to discharge refrigerant vapor separated from the lubricant; and
a flow director on the discharge tube,
wherein the flow director includes one or more surfaces that extend away from an outer dimension of the discharge tube, and
wherein the inlet includes an opening through which a majority of the outer dimension of the discharge tube is out of a line of sight as viewed through the opening of the inlet.

2. The lubricant separator of claim 1, wherein the fluid inlet comprises multiple inlets.

3. The lubricant separator of claim 1, wherein the fluid inlet comprises multiple inlets that have openings such that the discharge tube is out of sight relative to the openings of the inlet.

4. The lubricant separator of claim 1, wherein the fluid inlet comprises multiple inlets that have openings such that a majority of the discharge tube is out of sight relative to the openings of the inlets.

5. The lubricant separator of claim 1, wherein the discharge tube includes one or more openings along the length of the tube.

6. The lubricant separator of claim 5, wherein the one or more openings can be disposed at locations about the circumference of the discharge tube.

7. The lubricant separator of claim 1, wherein the flow director is a flare like structure including a drip edge.

8. The lubricant separator of claim 1, wherein the discharge tube is structurally secured at both ends to the vapor outlet and to a structure within the shell.

9. The lubricant separator of claim 2, wherein the inlets are on the same horizontal plane.

10. The lubricant separator of claim 2, wherein the inlets are on different horizontal planes.

11. The lubricant separator of claim 2, wherein the inlets are oriented at 90 to 180 degrees relative to each other about the circumference of the shell.

12. The lubricant separator of claim 2, wherein the inlets have openings that are angled relative to a horizontal plane.

13. The lubricant separator of claim 1, wherein an end of the discharge tube includes a plug.

14. The lubricant separator of claim 13, wherein the plug closes the end of the discharge tube.

15. A chiller or cooling system including the lubricant separator of claim 1.

16. A method of directing fluid flow through a cyclonic lubricant separator of claim 1, comprising:
directing a fluid into a fluid inlet of the shell of the lubricant separator, the fluid including refrigerant vapor and lubricant;
directing the fluid to swirl within the shell;
separating the lubricant from the refrigerant vapor, the separating includes removing lubricant from an outer surface of the discharge tube of the lubricant separator through use of the flow director of the lubricant separator, where separation of the lubricant from the outer surface of the discharge tube reduces entrainment of lubricant into the discharge tube;
discharging the refrigerant vapor through the vapor outlet of the lubricant separator; and
exiting lubricant through the liquid outlet of the lubricant separator.
